(19) United States
(12) Patent Application Publication
(10) Pub. No.: US 2004/0210754 A1
(43) Pub. Date: Oct. 21, 2004

(54) Shared security transform device, system and methods

(76) Inventors: Dwight L. Barron, Houston, TX (US); Daniel N. Cripe, Round Rock, TX (US); Michael F. Angelo, Houston, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/414,704

(22) Filed: Apr. 16, 2003

(51) Int. Cl. H04L 9/00

(52) U.S. Cl. 713/153; 713/201

(57) ABSTRACT

A shared security transform device is described as being usable to couple to a plurality of nodes via a common switch comprises control logic and memory coupled to the control logic. The memory may contain security information. The shared security transform device receives packets from any of the nodes via the switch and, using a value in the packets, retrieves security handling instructions to determine whether or not to apply a security transform to the packet. If a security transform is to be applied to the packet, the shared security transform device may determine which of a plurality of transforms is to be applied to the packet.

### BACKGROUND

Computers and computer-related devices (collectively referred to herein as “nodes”) can be coupled together via a network in a variety of fashions. Once the nodes are coupled together, data can be passed back and forth across the network. A number of security-related problems may be present in a multi-node network. For example, the data transmitted across a network from a source node to a destination node may contain sensitive information that only the intended destination node of the data should receive and be permitted access. Also, it is possible for one node to “impersonate” another node to be permitted access to that which only the latter node was permitted access. Such impersonating of nodes to obtain unauthorized access to information or resources may be referred to as “spoofing” and, of course, is generally undesirable in terms of system security. What it is desirable is to address any one or more of these security issues.

### BRIEF SUMMARY

One or more of the preceding issues may be addressed by systems and methods disclosed herein. In some embodiments, a shared security transform device usable to couple to a plurality of nodes via a common switch comprises control logic and memory coupled to the control logic. The memory may contain security information. The shared security transform device receives packets from any of the nodes via the switch and, using a value in the packets, retrieves security handling instructions to determine whether or not to apply a security transform to the packet. If a security transform is to be applied to the packet, the shared security transform device may determine which of a plurality of transforms is to be applied to the packet. Other embodiments may include a system having a plurality of nodes and a switch in which the shared security transform device also operates and associated methods.

### BRIEF DESCRIPTION OF THE DRAWINGS

For a detailed description of the embodiments of the invention, reference will now be made to the accompanying drawings in which:

FIG. 1 shows a system containing a shared security transform device in accordance with exemplary embodiments of the invention;

FIG. 2 shows an exemplary process usable in conjunction with the system of FIG. 1 to encrypt and transmit a packet through the shared security transform device;

FIG. 3 shows an exemplary embodiment of security information contained with the shared security transform device;

FIG. 4 shows another exemplary embodiment of security information contained with the shared security transform device;

FIG. 5 shows a process usable in conjunction with the system of FIG. 1 to detect unauthorized packets; and

FIG. 6 shows another exemplary embodiment of security information contained with the shared security transform device.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. All examples included herein should not be interpreted as limiting the scope of the disclosure in any way.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

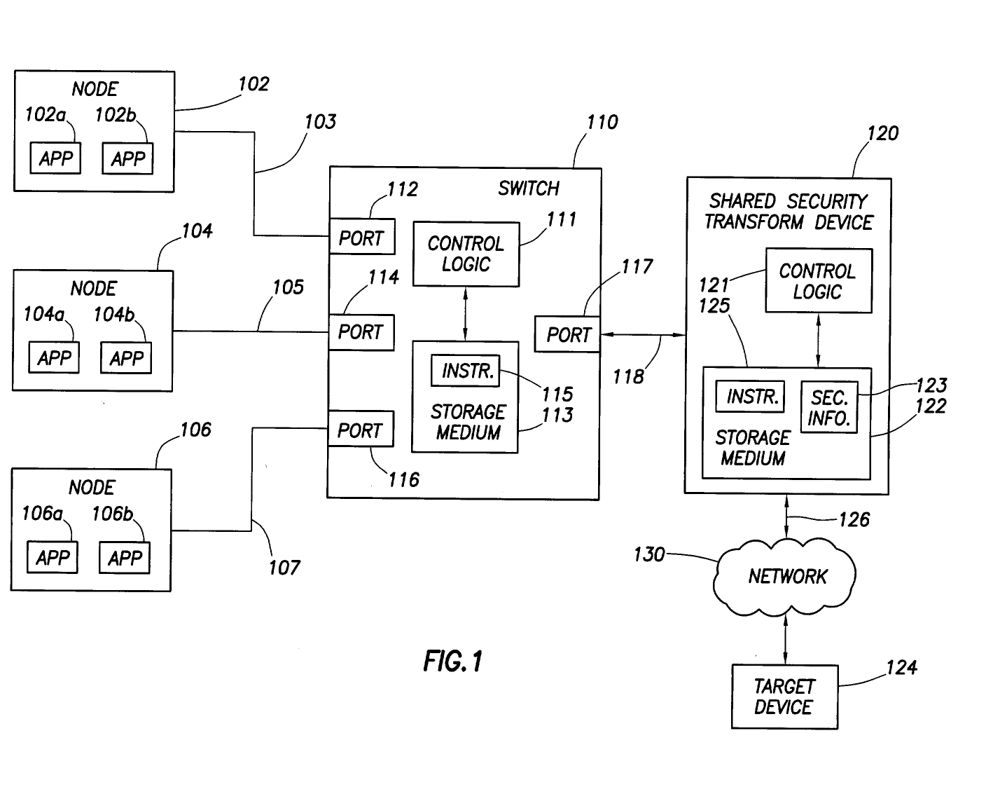

Referring now to FIG. 1, a system 100 may comprise nodes 102, 104 and 106 coupled to a switch 110 via links 103, 105, and 107 as shown. Switch 110, in turn, may couple via link 118 to a shared security transform device 120, which provides the system 100 with connectivity to a network 130. This configuration may permit one or more of the nodes 102-106 to communicate with each other or other devices coupled to the network 130, such as target device 124. The switch 110 may include ports 112, 114 and 116 to provide connectivity to the nodes 102-106 and port 117 to provide connectivity to the shared security transform device 120.

Numerous variations and embodiments of system 100 are possible and within the scope of this disclosure. For example, although three nodes 102, 104 and 106 are shown coupled to switch 110, any number of nodes (i.e., one or more) may be included. Each node 102-106 may have a unique Internet Protocol (“IP”) address associated therewith. Also, a node may comprise a computer (e.g., a server, laptop, etc.) or computer-related device (e.g., storage device). In some embodiments and without limitation, the nodes 102-106 may comprise “blade” servers housed within one or more racks or other types of support structures. Each node 102-106 may perform any one of a variety of functions. A node may run one or more applications, such as applications 102a, 102b, 104a, 104b, 106a, and 106b shown on nodes 102-106. The applications may comprise web server applications, database management, email services, etc.

Switch 110 may include control logic 111 which generally controls the operation of the switch and, as such, performs various actions such as coordinating the flow of packets between ports 112, 114, 116 and 117. The control logic 111 may comprise a processor or other type of control logic. The switch 110 also may include software instructions 115 stored on storage medium 113 (e.g., read only memory (“ROM”)). By executing the instructions 115, the control logic 111 may perform at least some of the actions described herein. Other components may be included within switch 110 as desired.

The shared security transform device 120 may include control logic 121, which may be the same or different as the control logic 111 of switch 110. In some embodiments, the control logic 121 may comprise a processor capable of executing instructions. Control logic 121 generally controls the operation of the shared security transform device 120. The shared security transform device 120 may also include a storage medium 122 (e.g., a ROM) in which security information 123 may be stored. The control logic 121 may have access to the security information 123 and use it as described below. The storage medium 122 may also include executable instructions 125 which, when executed by the control logic 121, may perform at least some of the functionality described herein.

Communications through the system 100 generally are bi-directional. For instance, nodes 102-106 may transmit packets though switch 110 and shared security transform device 120 to the target device 124 and the target device 124 may transmit packets in the opposite direction to a node 102-106.

In some embodiments, the packets transmitted between nodes 102-104 and switch 110 and between switch 110 and shared security transform device 120 may be unencrypted. As explained in more detail below, a function performed by the shared security transform device 120 is to encrypt packets received from the switch 110 over link 118 and transmit encrypted packets across the network 130 to target device 124. Similarly, encrypted packets received by the shared security transform device 120 over the network 130 from the target device 124 may be decrypted by the shared security transform device and provided to the switch 110 and then to a node 102-106 in unencrypted form. As such, the shared security transform device 124 provides security capabilities (e.g., encryption, decryption, etc.) on behalf of one or more nodes 102-104, thereby alleviating each node from having to include its own security device. As will become evident from the following discussion, the shared security transform device 120 provides network security in such way that permits each node to operate as though it had its own private/dedicated security device.

In accordance with some embodiments of the invention, the shared security transform device 120 may provide any one of a plurality of encryption transforms. Without limitation, such encryption transforms may include Internet Protocol Security (“IPSec”), Secured Socket Layer (“SSL”), etc. As described below, the shared security transform device 120 determines whether encryption is desired and if so, determines a suitable type of encryption transform to apply to each packet destined for network 130 and performs the transform.

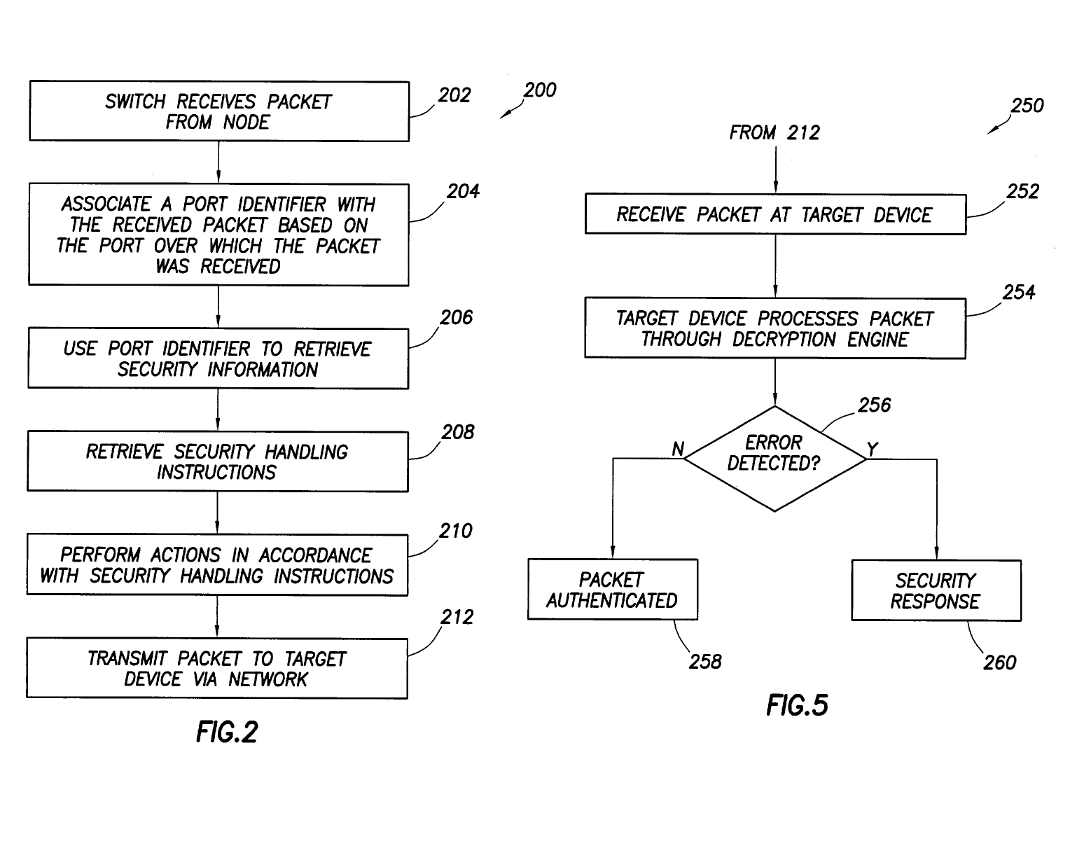

As can be observed from FIG. 1, a node 102, 104, or 106 provides packets to the switch 110 via a port 112, 114, or 116 on the switch 110 associated with each node 102-106. The packets may be formatted in accordance with any known standard(s) such as TCP/IP, UDP/IP, InfiniBand, FibreChannel or higher levels such as SSL or IPSEC and may include a source IP address and a destination IP address. FIG. 2 shows an exemplary process 200 usable with the system 100. The process 200 includes blocks 202-212. In block 202, the switch 110 receives a packet from one of the nodes 102-106. The switch 110 determines over which port 112-116 the packet was received. Of course, knowledge of the particularly port over which a packet is received is knowledge of which node transmitted the packet. Once the packet is received, in block 204 the switch 110 may associate a “port identifier” with the received packet. Each port 112-116 may be uniquely identified by a port identifier. For example, port 112's port identifier may be different from the port identifiers associated with ports 114 and 116. Similarly, the port identifier associated with port 114 may differ from the port identifier associate with ports 112 and 116. In some embodiments, the port identifiers may include virtual local area network (“LAN”) tags (“VTAGs”).

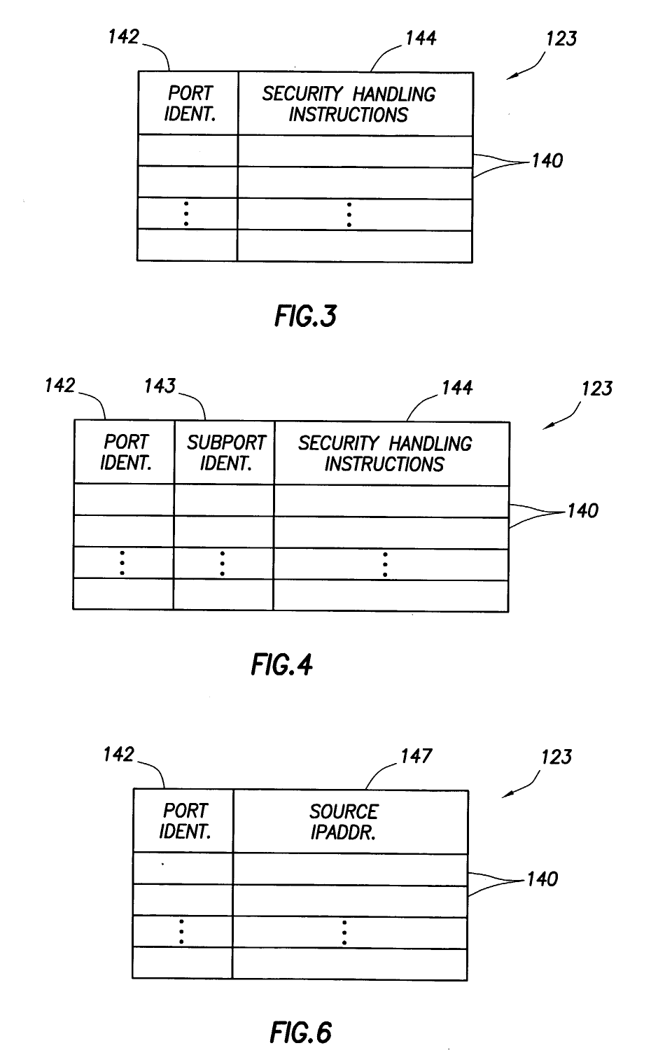

The packet received over a switch port 102-106 to which a port identifier is associated may be transmitted to the shared security transform device 120 over link 118. In block 206, the shared security transform device may use the packet's port identifier to retrieve security handling instructions from security information 123. Retrieving security handling instructions from the security information 123 may comprise using the port identifier as an index into the security information 123. An exemplary embodiment of security information 123 is shown in FIG. 3. The security information 123 may be implemented in the form of a table comprising a plurality of entries 140. Each entry may have a port identifier 142 associated with security handling instructions 144. The security handling instructions may specify one or more of the following: whether or not the packet is to be encrypted, the type of security transform (e.g., SSL, IPSec) that is to be applied for those packets that are to be encrypted, an encryption key to use in the encryption process, and any other desired type of security handling instructions. Security information 123 may be programmed via any one of a plurality of types of administrative network protocols.

If, in security information 123, a match is found to the packet's port identifier, the associated security handling instructions is retrieved in block 208. In block 210, the shared security transform device 120 performs the security actions in accordance with the security handling instructions retrieved in block 208. In block 212, the packet (which may or may not be encrypted) may be transmitted by the shared security transform device to a target device (e.g., target device 124) across the network 130

In accordance with the exemplary process 200 provided in FIG. 2, the nodes 102-106 may communicate through the common switch 110 and shared security transform device 120, but the packets generated by each node may undergo a security transform that may differ from the transforms used on other nodes' packets. For example, the packets from node 102 may be transformed in accordance with IPSec, while the packets from node 104 may be transformed in accordance with SSL. Further, the packets from some nodes may not be encrypted at all. The shared security transform device 120 may provide the flexibility to be customized to each node, thereby permitting each node to operate as if it had its own private security device.

FIG. 4 represents an embodiment of security information 123 which may be used to provide more than one set of security handling instructions for the same node. As explained above, a node 102-106 may include a plurality of applications running thereon. In accordance with some embodiments of the invention, it may be desired to implement security transformations based, not only on the port identifier (i.e., node), but also based on an application running on the node associated with the port identifier. For example, and referring briefly to FIG. 1, packets generated by, or on behalf of, node 102's application 102a may prefer IPSec for a security transform while packets generated by, or on behalf of, application 102b running on the same node 102 may prefer SSL for a security transform. Further still, it may be desirable not to implement any encryption on packets resulting from another application running on the same node 102. As such, a value may be included in the packet transmitted by a node 102-106 to the switch 110 which may be indicative of the application 102a-106b that caused the packet to be transmitted. The application-identifying value may comprise an index, source, destination, authorization/authorization mask, or other controlling data. In accordance with block 204 in FIG. 2, the switch 110, in this embodiment, may associate a port identifier with the received packet based on the port over which the packet was received. The switch 110 may also associate a sub-port identifier with the packet based on the application identified in the received packet that caused the packet to be generated. The sub-port identifier may be implemented as indexes, tags, or nodal addresses.

FIG. 4 shows an embodiment of security information 123 which takes into account port and sub-port identifiers. Each of the plurality of entries 140 may include three fields of information 142, 143 and 144. As described previously, fields 142 and 144 include port identifiers and security handling instructions, respectively. Field 143 may include sub-port identifiers. Each port identifier 142 may include one or more sub-port identifiers. The same or different security handling instruction may be programmed into security information 123 for each port/sub-port identifier combination. In this way, a greater degree of control may be provided over the security implementation provided for a node and the processes/applications that run thereon.

In at least some embodiments of the invention, “spoofing” may be prevented. FIG. 1 shows a configuration in which multiple nodes couple to a common switch. With a common switch 110, one node 102-106 may attempt to transmit a packet having a source IP address that corresponds to the IP address of another node. The port identifier may be helpful to address this issue. FIG. 5 shows an exemplary process for preventing spoofing.

Referring now to FIG. 5, an exemplary process 250 may continue where process 200 (FIG. 2) ended. Process 250 may include blocks 252-260. In block 252, the packet is received by the target device 124. The target device 124 may be configured to receive packets from a certain IP source address that are encrypted according to a predetermined security transform. In block 254, the target device 124 may process the incoming packet (that may comprise a spoof packet) through a decryption engine contained within the target device. The decryption engine (not specifically shown in FIG. 1), generally reverses the encryption process that presumably was used to encrypt the packet in the first place. If a legitimate source node generated the packet, the packet may be encrypted using the correct security transform by the shared security transform device 120 in block 210 of FIG. 2. In decision block 256 of FIG. 5, once decrypted, the target device 124 may determine whether or not an error occurred with the decryption process. This determination may include a validation of the message via a hash, or via other cryptographic validation techniques such as digital signatures, or validation via nodal routing. If no error occurred, control passes to block 258 in which the packet received by the target device 124 may be determined to be authentic.

If, however, another node 102-106 attempted to transmit a spoof packet, the attempted spoof packet may include the legitimate node's IP address as the packet's source IP, but have a port identifier associated with the unauthorized node (i.e., the node initiating the spoof packet) via action of the switch as in block 204 of FIG. 2. When this mismatched packet (i.e., a packet with an IP source address corresponding to one node, but with a port identifier corresponding to a different node) is received by the shared security transform device 124, the transform device, per blocks 208-210 in FIG. 2, may attempt to retrieve security handling instructions from security information 123 associated with packet's port identifier. In this embodiment, the handling instructions 144 in the security information 123 associated with the packet's port identifier will be retrieved. The handling instructions may include a key which will be a key associated with the packet's port identifier which may be used as an index into the security information 123. As such, if encryption is performed on the packet in block 210, an encryption key and transform will be used that corresponds to the unauthorized node, not the legitimate source node. In some applications, the security information 123 may not have a set of handling instructions 144 associated with the packet's port identifier. In this latter case, the packet will be transmitted to the target device 124 in unencrypted form.

As explained above, the packet, which may be encrypted according to the node that is attempting the spoof, is processed by the target device's decryption engine. The decryption process may use a decryption key that corresponds to the key associated with the legitimate source node. Because the spoofed packet may have been encrypted using, in effect, the wrong encryption key or may not have been encrypted at all, the decryption process at the target device 124 will not decrypt the packet in a way so as to recover the original data payload contained in the packet. That is, an error will be detected in decision block 256 and control may pass to block 260 in which the target device may perform a predetermined security response. The security response may include dropping the packet (i.e., no further processing or use of the packet), causing a security message packet to be generated and transmitted to a network administrator, and the like.

In other embodiments, the shared security transform device 120 may detect an attempted spoof and prevent the packet from being transmitted across the network 130. This may be accomplished in any of a variety of ways. Without limitation, one way may include the shared security transform device 120 comparing the combination of the packet's port identifier and source IP address to the security information 123. An embodiment of the security information 123 usable in this context may include information such as that shown in FIG. 6. As shown, security information 123 may include a plurality of entries 140 wherein each entry may include a port identifier 142 and an IP address 147. In general, each entry may include the port identifier an IP address combination that corresponds to the same node. For example, an entry 140 may include node 102's IP address and the port identifier of port 112 that also corresponds to node 102. It should be understood that the IP address field 147 may be included in the other embodiments of the security information 123 such as those shown in FIGS. 3 and 4. By including the port identifiers and IP addresses that correspond to the same node in the security information 123, the shared security transform device 120 may determine whether an entry 140 exists that includes a port identifier/IP address that matches the port identifier and source IP address in the packet. If no match is found (meaning that the port identifier and source IP correspond to two different nodes), the shared security transform device 120 may determine that the packet is not authorized (e.g., an attempted spoof) and perform an appropriate security action. Examples of appropriate security actions may include dropping the packet, transmitting a security alert packet to a network administrator, and the like.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A shared security transform device usable to couple to a plurality of nodes via a common switch, comprising:
control logic;
memory coupled to said control logic, said memory containing security information;
wherein said shared security transform device receives packets from any of said nodes via said switch and, using a value in said packets, retrieves security handling instructions to determine whether or not to apply a security transform to said packet and, if a security transform is to be applied, which of a plurality of transforms is to be applied to said packet.

2. The shared security transform device of claim 1 wherein said switch comprises a plurality of ports, each port coupled to a node, and said security information comprises a table which includes a plurality of entries, each entry containing a port identifier and a security handling instruction, said port identifier being associated with one of the switch's ports.

3. The shared security transform device of claim 1 wherein said switch comprises a plurality of ports, each port coupled to a node, and said security information comprises a table which includes a plurality of entries, each entry containing a port identifier, a sub-port identifier, and a security handling instruction, said port identifier being associated with one of the switch's ports and said sub-port identifier identifying an application that runs on a node.

4. The shared security transform device of claim 1 wherein said switch comprises a plurality of ports, each port coupled to a node, and said security information comprises a table which includes a plurality of entries, each entry containing a port identifier and a source IP address, said port identifier being associated with one of the switch's ports and said source IP address associated with the node that couples to the port to which the port identifier is associated.

5. The shared security transform device of claim 1 wherein at least one of said security handling instructions includes an encryption key.

6. The shared security transform device of claim 1 wherein said value comprises a virtual LAN tag placed in said packet by said switch to correspond to the node that transmitted the packet to the switch.

7. The shared security transform device of claim 6 wherein said packets also include a source IP address and said shared security transform device compares the virtual LAN tag and the source IP address to said security information to determine if the source IP address corresponds to the same node that the virtual LAN tag corresponds to.

8. The shared security transform device of claim 7 wherein if the source IP address and the virtual LAN tag do not correspond to the same node, the control logic prevents the packet from being transmitted to a destination address.

9. A system, comprising:
a plurality of nodes;
a switch to which said nodes couple;
a shared security transform device coupled to said switch and to a network, said nodes transmitting packets to and receiving packets from a target device attached to said network, said shared security transform device containing security information;
wherein said shared security transform device receives packets from any of said nodes via said switch and, using a value in said packets, retrieves security handling instructions to determine whether or not to apply a security transform to said packet and, if a security transform is to be applied, which of a plurality of transforms is to be applied to said packet.

10. The system of claim 9 wherein said switch comprises a plurality of ports, each port coupled to a node, and said security information comprises a table which includes a plurality of entries, each entry containing a port identifier and a security handling instruction, said port identifier being associated with one of the switch's ports.

11. The system of claim 9 wherein said switch comprises a plurality of ports, each port coupled to a node, and said security information comprises a table which includes a plurality of entries, each entry containing a port identifier, a sub-port identifier, and a security handling instruction, said port identifier being associated with one of the switch's ports and said sub-port identifier identifying an application that runs on a node.

12. The system of claim 9 wherein said switch comprises a plurality of ports, each port coupled to a node, and said security information comprises a table which includes a plurality of entries, each entry containing a port identifier and a source IP address, said port identifier being associated with one of the switch's ports and said source IP address associated with the node that couples to the port to which the port identifier is associated.

13. The system of claim 9 wherein at least one of said security handling instructions includes an encryption key.

14. The system of claim 9 wherein said value comprises a virtual LAN tag placed in said packet by said switch to correspond to the node that transmitted the packet to the switch.

15. The system of claim 14 wherein said packets also include a source IP address and said shared security transform device compares the virtual LAN tag and the source IP address to said security information to determine if the source IP address corresponds to the same node that the virtual LAN tag corresponds to.

16. The system of claim 15 wherein if the source IP address and the virtual LAN tag do not correspond to the same node, the control logic prevents the packet from being transmitted to a destination address.

17. A system, comprising:
a plurality of nodes;
a switch to which said nodes couple;
a means for transmitting packets to and receiving packets from a target device attached to said network and for containing security information, and for receiving packets from any of said nodes via said switch and, using a value in said packets, for retrieving security handling instructions to determine whether or not to apply a security transform to said packet and, if a security transform is to be applied, for determining which of a plurality of transforms is to be applied to said packet.

18. A method usable in a system comprising a plurality of nodes coupled to a common switch, comprising:
receiving a packet from a node at a port on the switch;
associating a port identifier with the received packet based on the port over which the packet was received;
using the port identifier as an index into security information;
retrieving security handling instructions based on the port identifier; and
performing actions on the packet as specified by the security handling instructions.

19. The method of claim 18 wherein performing actions includes encrypting said packet.

20. The method of claim 19 further including transmitting said packet to a target device.

21. The method of claim 20 further including receiving said packet at said target device and decrypting said packet.

22. The method of claim 21 further including determining whether or not the packet is authentic based on the results of said decrypting.

23. A method usable in a system comprising a plurality of nodes coupled to a common switch, comprising:
generating a packet having a source IP address that corresponds to an IP address of another node;
receiving the packet at a port on the switch;
associating a port identifier with the received packet based on the port over which the packet was received;
comparing the port identifier and the source IP address of the packet with security information to determine if the port identifier and the source IP address correspond to the same node;
performing a security action if the port identifier and source IP address do not correspond to the same node.

24. The method of claim 23 wherein the security action comprises preventing the packet from being transmitted to a target device.
